(19) United States
(12) Patent Application Publication
(10) Pub. No.: US 2020/0149573 A1
(43) Pub. Date: May 14, 2020

(54) Headboard Mounting Assembly and System

(71) Applicant: Click Flip LLC, Sioux Falls, SD (US)

(72) Inventor: Nathan Rons, Denver, CO (US)

(73) Assignee: Click Flip LLC, Sioux Falls, SD (US)

(21) Appl. No.: 16/184,318

(22) Filed: Nov. 8, 2018

(51) Int. Cl. F16B 12/56; A47C 19/00

(52) U.S. Cl. CPC F16B 12/56; A47C 19/005

(57) ABSTRACT

A headboard mounting assembly and system includes a plate with four quadrants including a first quadrant, a second quadrant, a third quadrant and a fourth quadrant. The first quadrant is pivotally coupled to the second and fourth quadrants, the second quadrant is pivotally coupled to the third quadrant, and the third and fourth quadrants are separated from each other. The plate is positionable in a stored condition wherein the four quadrants are co-planar with each other. The plate is positionable in a deployed condition wherein each quadrant of the four quadrants is orientated perpendicular to an adjacent one of the quadrants and the third and fourth quadrants overlap to define a bottom wall. The bottom wall is secured to a bed frame with a plurality of frame fasteners and the second quadrant is secured to a headboard with a plurality of headboard fasteners.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to headboard bracket devices and more particularly pertains to a new headboard bracket device for which may be flattened to facilitate transportation while having a structure adaptable to multiple bed frames and headboards.

### BRIEF SUMMARY OF THE INVENTION

An embodiment of the disclosure meets the needs presented above by generally comprising a plate with four quadrants including a first quadrant, a second quadrant, a third quadrant and a fourth quadrant. The first and third quadrants are positioned opposite of each other. The first quadrant is pivotally coupled to the second and fourth quadrants, the second quadrant is pivotally coupled to the third quadrant, and the third and fourth quadrants are separated from each other. The plate is positionable in a stored condition wherein the four quadrants are co-planar with each other. The plate is positionable in a deployed condition wherein each quadrant of the four quadrants is orientated perpendicular to an adjacent one of the quadrants and the third and fourth quadrants overlap to define a bottom wall. The bottom wall is secured to a bed frame with a plurality of frame fasteners and the second quadrant is secured to a headboard with a plurality of headboard fasteners.

Wherein another embodiment of the disclosure includes a plate with four quadrants pivotally coupled together and including a first quadrant, a second quadrant, a third quadrant and a fourth quadrant wherein the first and third quadrants are positioned opposite of each other. The plate is positionable in a stored condition wherein the four quadrants are co-planar with each other. The plate is positionable in a deployed condition wherein each quadrant of the four quadrants is orientated perpendicular to an adjacent one of the quadrants and the third and fourth quadrants overlap to define a bottom wall. A bed frame has a corner. A plurality of frame fasteners extends into the bottom wall and into the bed frame adjacent to the corner. A headboard has a front side that is positioned adjacent to an end edge of the bed frame. A plurality of headboard fasteners extends through the second quadrant and into the front side of the headboard.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric in-use view of a headboard mounting assembly and system according to an embodiment of the disclosure.

FIG. 2 is a cross-sectional view of an embodiment of the disclosure taken along line 2-2 of FIG. 1.

FIG. 3 is a front view of an embodiment of the disclosure a stored condition.

FIG. 4 is a front view of an embodiment of the disclosure in a stored condition.

FIG. 5 is an isometric view of an embodiment of the disclosure in a deployed condition.

FIG. 6 is an isometric view of an embodiment of the disclosure in an intermediate condition between the stored and deployed conditions.

### DETAILED DESCRIPTION OF THE INVENTION

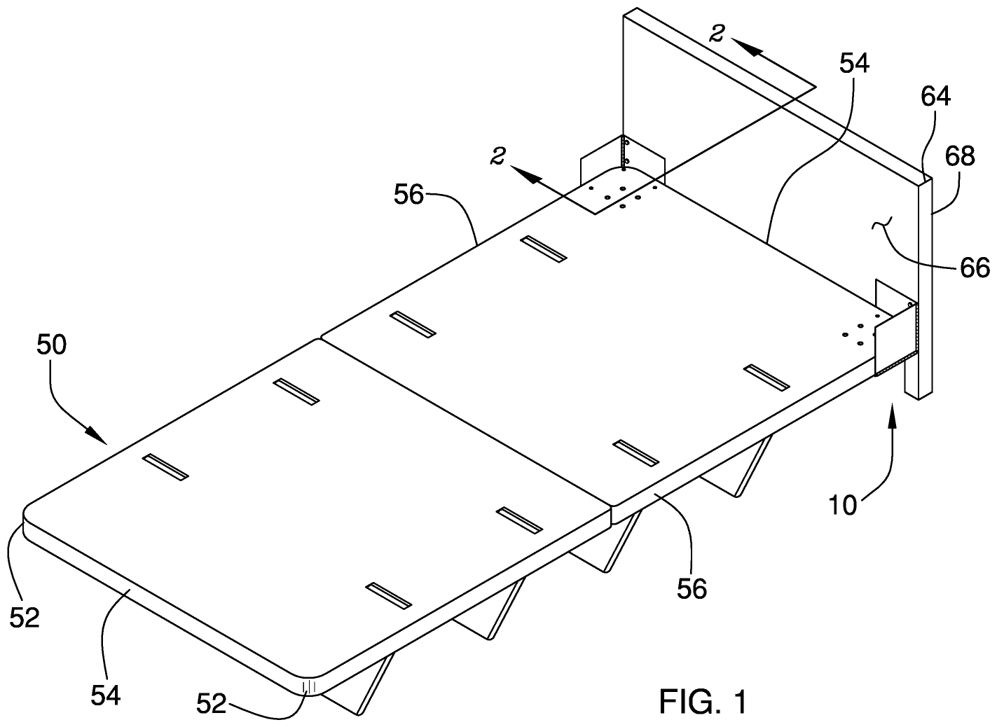

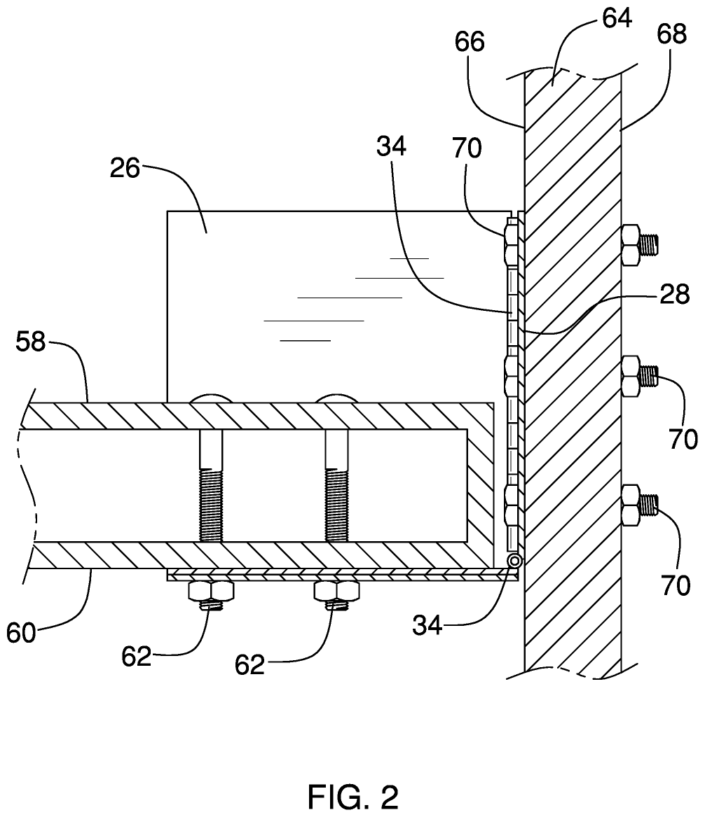

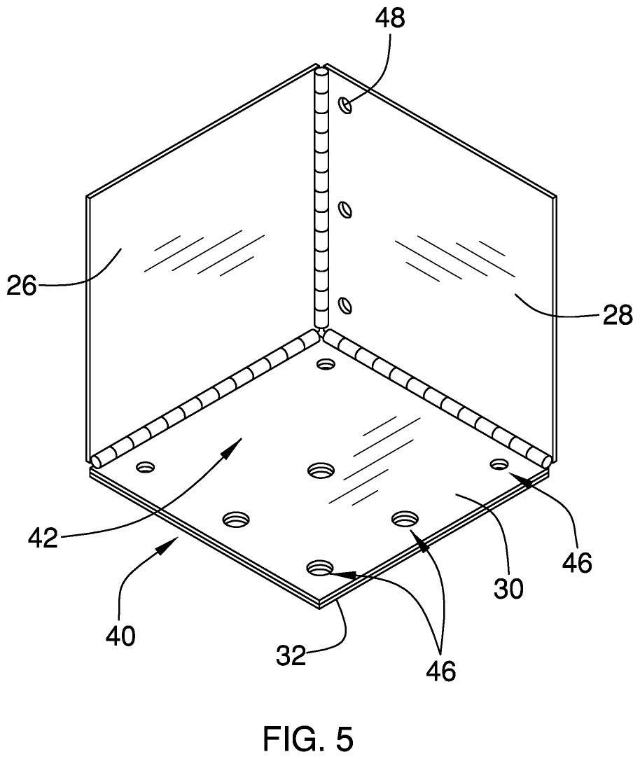

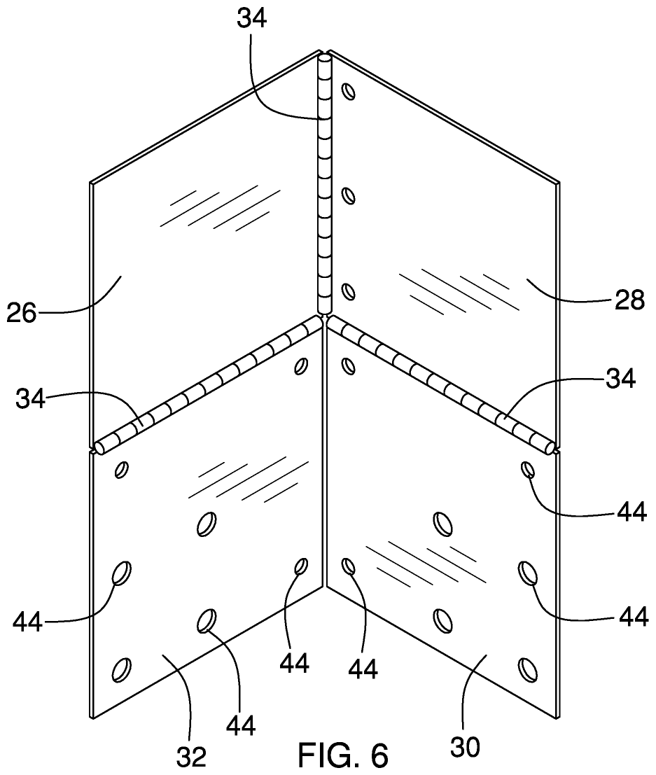

With reference now to the drawings, and in particular to FIGS. 1 through 6 thereof, a new headboard bracket device embodying the principles and concepts of an embodiment of the disclosure and generally designated by the reference numeral 10 will be described.

As best illustrated in FIGS. 1 through 6, the headboard mounting assembly and system 10 generally comprises a plate 12 with a first edge 14, a second edge 16, a third edge 18 and a fourth edge 20 wherein the first 14 and third 18 edges are positioned opposite of each other and the second 16 and fourth 20 edges are positioned opposite of each other. The plate 12 is comprised of a rigid material which may include wood, composites, plastics, metals and the like. The plate 12 has a first dividing line 22 extending from the first edge 14 to the third edge 18 and a second dividing line 24 extending from the second edge 16 to the fourth edge 20.

The first 22 and second 24 dividing lines define a plurality of quadrants, or plate sections, of the plate 12 and include a first quadrant 26 including the first 14 and fourth 20 edges, a second quadrant 28 including the first 14 and second 16 edges, a third quadrant 30 including the second 16 and third 18 edges, and a fourth quadrant 32 including the third 18 and fourth 20 edges. The first 26 and third 30 quadrants are positioned opposite of each other. The first quadrant 26 is pivotally coupled to the second 28 and fourth 32 quadrants, the second quadrant 28 is pivotally coupled to the third quadrant 30, and the third 30 and fourth 32 quadrants are separated from each other. Where pivoting connections are present, such may be accomplished in any conventional manner such as conventional hinges 34 including knuckles positioned on the associated quadrants and hinge pins connecting knuckles of adjacent quadrants, swivel or ball joints, or with living hinges 36. The living hinges 36 may be formed out of thinned areas of the panel extending along the first 22 and second 24 dividing lines or made easier to bend by perforating the first 22 and second 24 dividing lines with a plurality of holes 38.

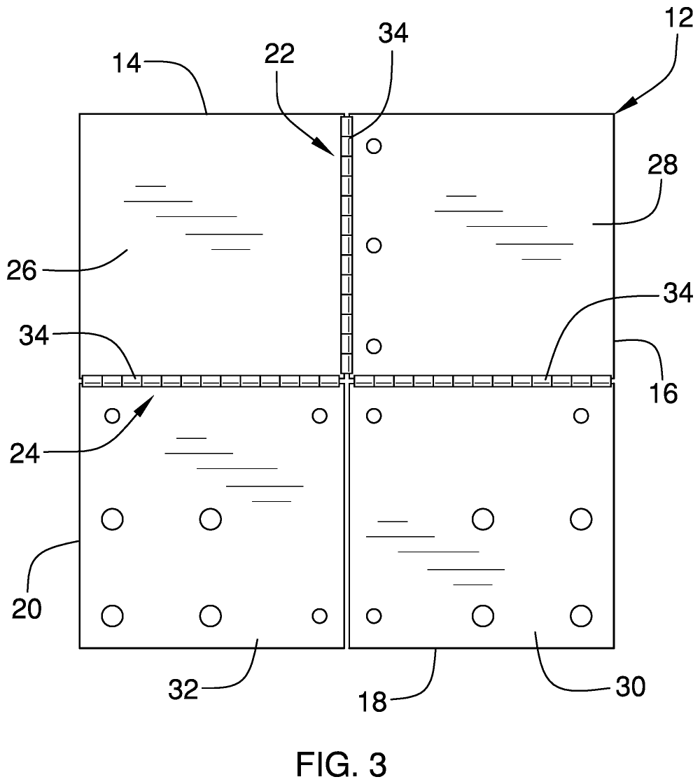

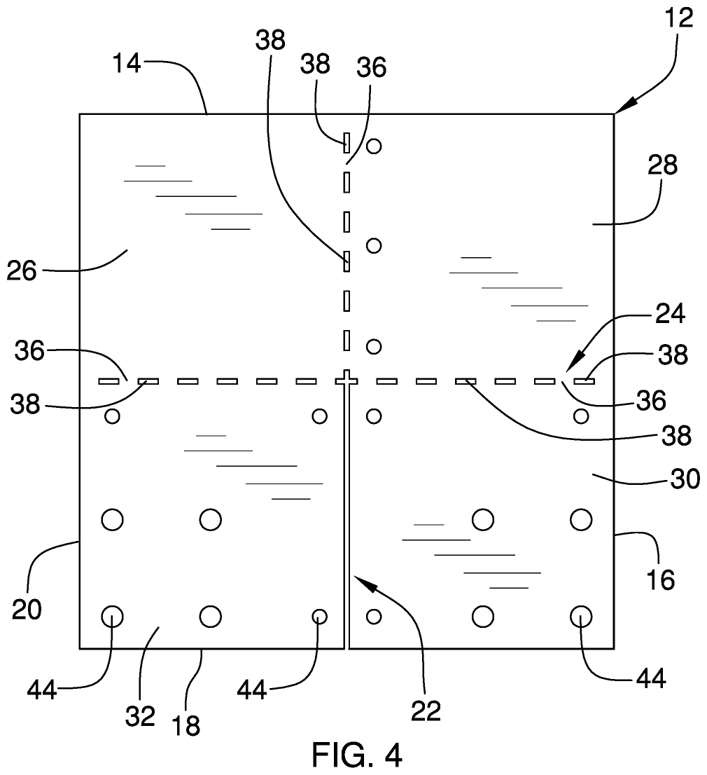

The first through the fourth 26-32 quadrants are positionable in a co-planar configuration to define a stored condition as shown in FIGS. 3 and 4. It is in this condition that the plate 12 will be stored and shipped as it will require little space for shipment. The length and width of the plate 12 will each typically be greater than 6.0 inches and less than 24.0 inches as size variances may be needed to account for different sized bed components to be attached together.

The plate 12 is pivotable along the first dividing 22 line such that the first 26 and second 28 quadrants are orientated perpendicular to each other and the plate 12 is pivotable along the second dividing line 24 to thereafter overlap the third 30 and fourth 32 quadrants to define a deployed condition. The third 30 and fourth 32 quadrants define a bottom wall 40 when the plate 12 is in the deployed condition. As can be seen in the Figures, a receiving space 42 in the shape of a half cube is thus formed which is bounded by the bottom wall 40, first quadrant 26 and second quadrant 28.

The third 30 and fourth 32 quadrants each have a plurality of mounting apertures 44 extending therethrough. The mounting apertures 44 in the third quadrant 30 are aligned with the mounting apertures 44 in the fourth quadrant 32 when the plate 12 is in the deployed condition to define aligned apertures 46. Furthermore, the second quadrant 28 has a plurality of mounting openings 48 extending therethrough. The mounting apertures may be positioned in central areas of the third 30 and fourth 32 quadrants or they may be positioned along the edges of thereof. The multiple positions allow the plate 12 of the system 10 to accommodate a number of different types of bed frames.

A bed frame 50 is provided which is configured for supporting a mattress. The bed frame 50 shown in FIG. 1 is a modular bed frame though any conventional bed frames common for supporting a mattress above a floor surface and which have exposed corners may be utilized instead. The bed frame 50 has a corner 52 that includes an end edge 54, a lateral edge 56, an upper surface 58 and a lower surface 60. It should be readily appreciated that the bed frame 50 will have four corners 52 each having the same elements and, consequently, the system 10 would typically include at least two plates 12 but may include four plates 12 for reasons discussed below. The bottom wall 40 is abuttable against the lower surface 60 when the first quadrant 26 is positioned against the lateral edge 56 and the second quadrant 28 is positioned against the end edge 54. Alternatively, the bottom wall 40 may be positioned on the upper surface 58 while the second quadrant 28 is positioned generally co-planar with the end edge 54.

A plurality of frame fasteners 62 is provided which comprise, for example, nuts and bolts or other securing members conventional to attaching brackets to a bed frame. Each frame fasteners 62 extends through one of the aligned apertures 46 and into the bed frame to releasably couple the third 30 and fourth 32 quadrants to the bed frame 50.

A headboard 64 includes a front side 66 and a back side 68. The front side 66 is positioned adjacent to and extends along the end edge 54 of the bed frame 50. It is noted that while a headboard 64 is used as an example, headboards and footboards are considered interchangeable and are therefore defined herein as analogous structures. Thus, the system 10 may require four plates 12 should both a headboard and a footboard be attached to the bed frame 50. A plurality of headboard fasteners 70 is provided and each of the headboard fasteners 70 extends through one of the mounting openings 48 and into the headboard 64 to releasably couple the headboard 64 to the second quadrant 28. As with the frame fasteners 62, the headboard fasteners 70 may include nuts and bolts or other securing members conventional to attaching brackets to headboards 64.

In use, the system 10 allows for a modular bed assembly that can be shipped in an efficient manner by using brackets that fold down to very a very thin profile which is typically going to be less than 0.5 inches. The plates 12 will be very inexpensive to manufacture and ship while at the same time being readily interchangeable with a plurality of bed frames 50 and headboards 64 simply by altering the pattern of aligned apertures or mounting openings.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A headboard mounting system for releasably securing a headboard to a bed frame, the system comprising:
a plate including four quadrants including a first quadrant, a second quadrant, a third quadrant and a fourth quadrant wherein the first and third quadrants are positioned opposite of each other, the first quadrant being pivotally coupled to the second and fourth quadrants, the second quadrant being pivotally coupled to the third quadrant, the third and fourth quadrants being separated from each other;
the plate being positionable in a stored condition wherein the four quadrants are co-planar with each other;
the plate being positionable in a deployed condition wherein each quadrant of the four quadrants is orientated perpendicular to an adjacent one of the quadrants and the third and fourth quadrants overlap to define a bottom wall;
wherein the bottom wall is configured to be secured to a bed frame with a plurality of frame fasteners; and
wherein the second quadrant is configured to be secured to a headboard with a plurality of headboard fasteners.

2. The headboard mounting system for releasably securing a headboard to a bed frame according to claim 1, wherein the quadrants are pivotally coupled together by a living hinge.

3. A headboard mounting system for releasably securing a headboard to a bed frame according to claim 1, wherein the four quadrants are pivotally coupled together by hinges.

4. A headboard mounting system for releasably securing a headboard to a bed frame according to claim 1, wherein the deployed condition defines a receiving space bounded by the first quadrant, the second quadrant and the bottom wall, the receiving space being configured to receive a corner of the bed frame such that the bottom wall abuts a lower surface of the bed frame.

5. A headboard mounting system for releasably securing a headboard to a bed frame, the system comprising:
a plate including four quadrants including a first quadrant, a second quadrant, a third quadrant and a fourth quadrant wherein the first and third quadrants are positioned opposite of each other, the first quadrant being pivotally coupled to the second and fourth quadrants, the second quadrant being pivotally coupled to the third quadrant, the third and fourth quadrants being separated from each other;
the plate being positionable in a stored condition wherein the four quadrants are co-planar with each other;
the plate being positionable in a deployed condition wherein each quadrant of the four quadrants is orientated perpendicular to an adjacent one of the quadrants and the third and fourth quadrants overlap to define a bottom wall;
a bed frame having a corner;
a plurality of frame fasteners extending into the bottom wall and into the bed frame adjacent to the corner;
a headboard having a front side being positioned adjacent to an end edge of the bed frame; and
a plurality of headboard fasteners extending through the second quadrant and into the front side of the headboard.

6. The headboard mounting system for releasably securing a headboard to a bed frame according to claim 5, wherein the four quadrants are coupled together by a living hinge.

7. A headboard mounting system for releasably securing a headboard to a bed frame according to claim 5, wherein the four quadrants are coupled together by hinges.

8. A headboard mounting system for releasably securing a headboard to a bed frame according to claim 5, wherein the deployed condition defines a receiving space bounded by the first quadrant, the second quadrant and the bottom wall, the receiving space receiving the corner of the bed frame such that the bottom wall abuts a lower surface of the bed frame.

9. A headboard mounting system for releasably securing a headboard to a bed frame, the system comprising:
a plate having a first edge, a second edge, a third edge and a fourth edge wherein the first and third edges are positioned opposite of each other and the second and fourth edges are positioned opposite of each other, the plate having a first dividing line extending from the first edge to the third edge and a second dividing line extending from the second edge to the fourth edge, the first and second dividing lines defining a first quadrant including the first and fourth edges, a second quadrant including the first and second edges, a third quadrant including the second and third edges, and a fourth quadrant including the third and fourth edges, said first dividing line pivotally coupling said first and second quadrants together and separating said third and fourth quadrants from each other;
the first through the fourth quadrants being positionable in a co-planar configuration defining a stored condition;
the plate being pivotable along the first dividing line such that the first and second quadrants are orientated perpendicular to each other and the plate being pivotable along the second dividing line to overlap the third and fourth quadrants to define a deployed condition, the third and fourth quadrants defining a bottom wall when the plate is in the deployed condition;
the third and fourth quadrants each having a plurality of mounting apertures extending therethrough, the mounting apertures in the third quadrant being aligned with the mounting apertures in the fourth quadrant when the plate is in the deployed condition to define aligned apertures;
the second quadrant having a plurality of mounting openings extending therethrough;
a bed frame configured for supporting a mattress, the bed frame having a corner including an end edge, a lateral edge, an upper surface and a lower surface, the bottom wall being abuttable against the lower surface when the first quadrant is positioned against the lateral edge and the second quadrant is positioned against the end edge;
a plurality of frame fasteners, each of the frame fasteners extending through one of the aligned apertures and into the bed frame to releasably couple the third and fourth quadrants to the bed frame;
a headboard having a front side and a back side, the front side being positioned adjacent to and extending along the end edge of the bed frame; and
a plurality of headboard fasteners, each of the headboard fasteners extending through one of the mounting openings and into the headboard to releasably couple the headboard to the second quadrant.

10. A headboard mounting system for releasably securing a headboard to a bed frame according to claim 1, wherein the first and second dividing lines comprise living hinges.

11. A headboard mounting system for releasably securing a headboard to a bed frame according to claim 1, wherein the first and second dividing lines comprise hinges.
